(19) United States
(12) Patent Application Publication
(10) Pub. No.: US 2014/0198054 A1
(43) Pub. Date: Jul. 17, 2014

(54) SCREEN FREEZING FOR A WIRELESS COMMUNICATION DEVICE

(71) Applicant: Sprint Communications Company L.P., (US)

(72) Inventors: Sanjay K. Sharma, Olathe, KS (US); Jessica L. Kemp, Raymore, MO (US); Peter S. Syromiatnikov, San Diego, CA (US); Kenneth Ray Steele, Overland Park, KS (US); John D. Sumler, Bonner Springs, KS (US)

(73) Assignee: SPRINT COMMUNICATIONS COMPANY L.P., Overland Park, KS (US)

(21) Appl. No.: 13/741,969

(22) Filed: Jan. 15, 2013

(51) Int. Cl. G06F 3/041

(52) U.S. Cl. CPC G06F 3/041
USPC 345/173

(57) ABSTRACT

A wireless communication device comprises a touchscreen and a processing system. The touchscreen is configured to display a graphical user interface. The processing system is configured to receive a freeze command from a user of the wireless communication device and, responsive to the freeze command, hold at least a portion of the touchscreen in a frozen state, direct the touchscreen to display a status notification indicating that the at least the portion of the touchscreen is in the frozen state, and unfreeze the at least the portion of the touchscreen responsive to an unfreeze event.

### TECHNICAL BACKGROUND

Modern wireless communication devices typically include a touchscreen that acts as both a display and input mechanism for the user. Such devices, often called smartphones, enable a user to perform several functions beyond simple mobile voice communication. For example, a user may download, install, and execute third-party applications, access websites, stream media, and perform other advanced functionality of which the smartphone is capable.

Typically, a wireless communication device includes various functions and associated settings provided by the operating system for configuring the device. A user is able to access and manipulate these settings in order to customize the various functions and overall operation of the device, thereby enhancing the user's experience. For example, a wireless communication device might have a battery-saving feature which turns off the display screen after a predetermined time period of inactivity, and the user can typically set the amount of time that must elapse before the screen automatically turns off. In some examples, a wireless communication device may also include an accelerometer, which can be utilized to sense an orientation of the device relative to the user's point of view and automatically rotate the images displayed on the screen to match this viewpoint. Further, most wireless communication devices equipped with a touchscreen include a screen lock function that locks the screen to avoid accidental user input or to prevent unauthorized usage. Once the screen is locked, the user must typically provide an input on the touchscreen in order to unlock the screen and regain control over the wireless communication device.

### OVERVIEW

A method of operating a wireless communication device is disclosed. The method comprises displaying a graphical user interface on a touchscreen of the wireless communication device. The method further comprises receiving a freeze command from a user of the wireless communication device. The method further comprises, responsive to the freeze command, holding at least a portion of the touchscreen in a frozen state. The method further comprises displaying a status notification indicating that the at least the portion of the touchscreen is in the frozen state. The method further comprises unfreezing the at least the portion of the touchscreen responsive to an unfreeze event.

A wireless communication device comprises a touchscreen and a processing system. The touchscreen is configured to display a graphical user interface. The processing system is configured to receive a freeze command from a user of the wireless communication device and, responsive to the freeze command, hold at least a portion of the touchscreen in a frozen state, direct the touchscreen to display a status notification indicating that the at least the portion of the touchscreen is in the frozen state, and unfreeze the at least the portion of the touchscreen responsive to an unfreeze event.

A computer apparatus comprises software instructions and at least one non-transitory computer-readable storage medium storing the software instructions. The software instructions are configured, when executed by a wireless communication device, to direct the wireless communication device to display a graphical user interface on a touchscreen of the wireless communication device. The software instructions are further configured to direct the wireless communication device to receive a freeze command from a user of the wireless communication device, and responsive to the freeze command, hold at least a portion of the touchscreen in a frozen state. The software instructions are further configured to direct the wireless communication device to display a status notification indicating that the at least the portion of the touchscreen is in the frozen state. The software instructions are further configured to direct the wireless communication device to unfreeze the at least the portion of the touchscreen responsive to an unfreeze event.

### BRIEF DESCRIPTION OF THE DRAWINGS

FIG. 1 is a block diagram that illustrates a wireless communication device.

FIG. 2 is a flow diagram that illustrates an operation of the wireless communication device.

FIG. 3 is a block diagram that illustrates an operation of a wireless communication device in an exemplary embodiment.

FIG. 4 is a block diagram that illustrates an operation of a wireless communication device in an exemplary embodiment.

FIG. 5 is a block diagram that illustrates an operation of a wireless communication device in an exemplary embodiment.

FIG. 6 is a block diagram that illustrates a wireless communication device.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

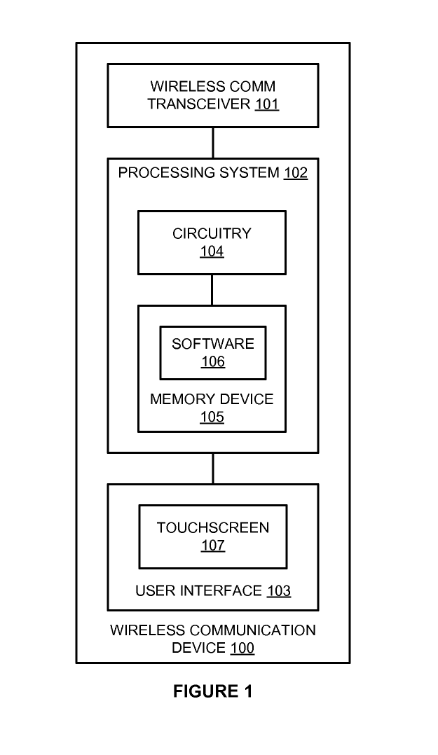

FIG. 1 is a block diagram that illustrates wireless communication device 100. Wireless communication device 100 includes wireless communication transceiver 101, processing system 102, and user interface 103. Processing system 102 is linked to wireless communication transceiver 101 and user interface 103. Processing system 102 includes processing circuitry 104 and memory device 105 that stores operating software 106. User interface 103 includes touchscreen 107.

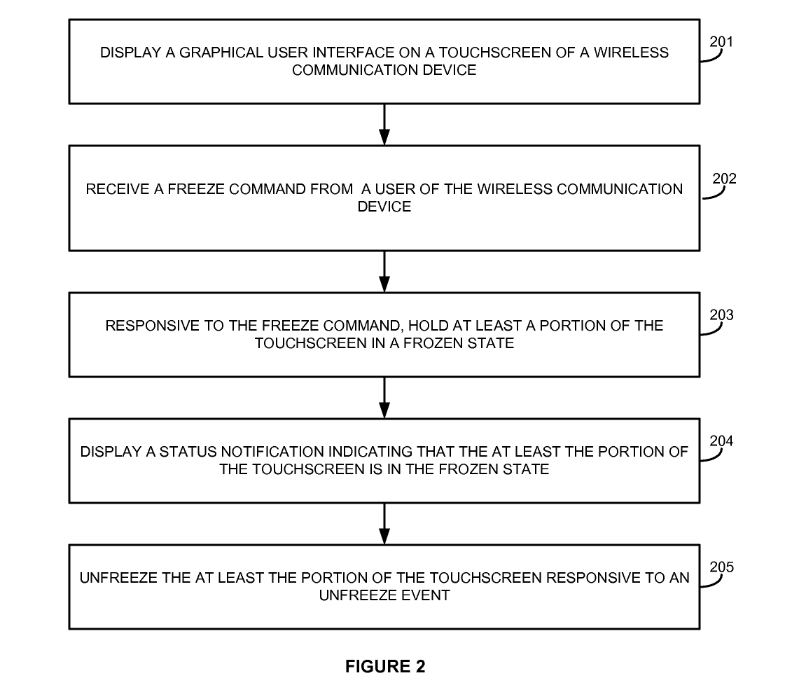

FIG. 2 is a flow diagram that illustrates an operation of wireless communication device 100. The steps of the operation are indicated below parenthetically. The operation of wireless communication device 100 shown in FIG. 2 may typically be employed by an operating system of wireless communication device 100, but could also be performed by an application, script, or any other executable code contained in software and/or embedded in hardware.

To begin, wireless communication device 100 displays a graphical user interface on touchscreen 107 (201). The graphical user interface displayed by wireless communication device 100 typically includes a background image, icons, soft buttons, and a status bar displaying the date and time, wireless signal strength, an active wireless protocol, remaining battery power, and notifications such as incoming voicemail messages, email messages, short message service (SMS) messages, and calls. The graphical user interface displayed on touchscreen 107 can also typically include various menus and settings that enable a user of wireless communication device 100 to configure the device. Of course, in some examples, wireless communication device 100 may not be equipped with touchscreen 107, in which case some other display element of user interface 103 would display the graphical user interface.

Wireless communication device 100 receives a freeze command from a user of wireless communication device 100 (202). The freeze command could be input into wireless communication device 100 in a variety of ways. For example, the user could press a dedicated hard button on user interface 103 to input the freeze command to wireless communication device 100. In another example, the user could press a soft button or icon appearing on touchscreen 107 to input the freeze command, or access a special menu to input the freeze command. For example, the user could press and hold a finger anywhere on touchscreen 107 to access the special menu and then select an option from that menu to input the freeze command. In some examples, the user could also speak the freeze command into a microphone of wireless communication device 100 and voice recognition software could receive and interpret the spoken freeze command. Wireless communication device 100 could also receive the freeze command from the user from other user input techniques. In some examples, receiving the freeze command from the user could include receiving a selection of at least the portion of touchscreen 107. For example, the user could drag a finger around the portion of touchscreen 107 that the user desires to freeze as part of inputting the freeze command.

Responsive to the freeze command, wireless communication device 100 holds at least a portion of touchscreen 107 in a frozen state (203). Typically, when wireless communication device 100 holds the portion of touchscreen 107 in the frozen state, whatever is displayed in that portion of touchscreen 107 will continue being displayed without any obstruction or interference from other screen elements, applications, or other functions performed by an operating system of wireless communication device 100. For example, wireless communication device 100 may have a feature which causes touchscreen 107 to automatically turn off after a set time period to conserve battery power, but when holding at least a portion of touchscreen 107 in a frozen state, at least that portion of the screen would remain visible and not go dark. In other words, wireless communication device 100 would maintain a brightness of touchscreen 107 while at least a portion of touchscreen 107 is being held in a frozen state. In some examples, wireless communication device 100 could also include an accelerometer used to detect an orientation of wireless communication device 100 and automatically rotate the display on touchscreen 107 to match the user's point of view, but when holding at least a portion of touchscreen 107 in a frozen state, wireless communication device 100 would override this feature and prevent touchscreen 107 from rotating while the portion of touchscreen 107 is in the frozen state.

In some examples, the portion of touchscreen 107 that is held in the frozen state is the entire display area of touchscreen 107. In other examples, the portion of touchscreen 107 that is held in the frozen state is the entire display area of touchscreen 107 except for a status bar which displays notifications to the user such as the date and time, wireless signal strength, an active wireless protocol, remaining battery power, incoming voicemail messages, email messages, SMS messages, calls, and the like. In some examples, when a user receives an incoming call on wireless communication device 100, an incoming call dialog box is displayed on the entire touchscreen 107 and any applications, images, and other screen elements that were being displayed on touchscreen 107 before the incoming call dialog box was displayed are no longer visible. However, when holding at least a portion of touchscreen 107 in a frozen state, wireless communication device 100 would prevent touchscreen 107 from displaying an incoming call notification on at least the portion of touchscreen 107 that is in the frozen state. Instead, the incoming call notification might only be displayed in the status bar of wireless communication device 100 to avoid obstructing the display area of touchscreen 107 that is held in the frozen state.

In addition to holding at least a portion of touchscreen 107 in the frozen state, wireless communication device 100 could display a status notification indicating that at least the portion of the touchscreen 107 is in the frozen state (204). The status notification indicating the frozen state would typically be displayed in the same status area as the date and time, wireless signal strength, and other notifications, although the status notification could be displayed in other areas of touchscreen 107 in some examples. The status notification provides a visual indicator to a user of wireless communication device 100 that wireless communication device 100 has processed the freeze command from the user and is holding at least a portion of touchscreen 107 in a frozen state. In some examples, the status notification indicating that at least the portion of the touchscreen 107 is in the frozen state could also provide a mechanism for the user of wireless communication device 100 to request unfreezing the portion of touchscreen 107 that is being held in the frozen state.

Wireless communication device 100 is configured to unfreeze the portion of touchscreen 107 that is being held in the frozen state responsive to an unfreeze event (205). The unfreeze event could be any event that signals to wireless communication device 100 that touchscreen 107 should be unfrozen. In some examples, if touchscreen 107 is held in the frozen state for a duration of a timer, the unfreeze event could comprise the expiration of the timer. In other examples, the unfreeze event could comprise an unfreeze command from the user. For example, the user could press a hard button on user interface 103, tap a soft button or icon appearing on touchscreen 107, speak a voice command, or provide some other user input to signal to wireless communication device 100 a desire to unfreeze the portion of touchscreen 107 that is being held in the frozen state. In some examples, when wireless communication device 100 unfreezes the portion of touchscreen 107 responsive to the unfreeze event, wireless communication device 100 could also remove the status notification that was indicating the frozen state.

Advantageously, wireless communication device 100 can freeze just a portion of a display on touchscreen 107 or the entire touchscreen 107 responsive to a freeze command. Touchscreen 107 that is held in the frozen state can then be unfrozen in response to an unfreeze event. Accordingly, the user of wireless communication device 100 is afforded more control over both what is displayed on touchscreen 107 and the manner in which wireless communication device 100 operates touchscreen 107, thereby providing an enhanced user experience and increased user satisfaction.

Referring back to FIG. 1, wireless communication device 100 comprises any device having wireless communication connectivity with hardware and circuitry programmed to function as a telecommunications device, such as Radio Frequency (RF) communication circuitry and an antenna. The RF communication circuitry typically includes an amplifier, filter, modulator, and signal processing circuitry. Wireless communication device 100 may also include a user interface, memory system, software, processing circuitry, or some other communication components. For example, wireless communication device 100 could comprise a telephone, transceiver, mobile phone, cellular phone, smartphone, computer, personal digital assistant (PDA), e-book, game console, mobile Internet device, wireless network interface card, media player, or some other wireless communication apparatus—including combinations thereof. Wireless network protocols that may be utilized by wireless communication device 100 include Code Division Multiple Access (CDMA) 1xRTT, Global System for Mobile communications (GSM), Universal Mobile Telecommunications System (UMTS), High-Speed Packet Access (HSPA), Evolution-Data Optimized (EV-DO), EV-DO rev. A, B, and C, Third Generation Partnership Project Long Term Evolution (3GPP LTE), LTE Advanced, Worldwide Interoperability for Microwave Access (WiMAX), IEEE 802.11 protocols (Wi-Fi), Bluetooth, Internet, telephony, or any other wireless network protocol that facilitates communication between wireless communication device 100 and a wireless communication network.

In this example, wireless communication device 100 includes wireless communication transceiver 101, processing system 102, and user interface 103. Processing system 102 is linked to wireless communication transceiver 101 and user interface 103. Processing system 102 includes processing circuitry 104 and memory device 105 that stores operating software 106. Wireless communication device 100 may include other well-known components such as a battery and enclosure that are not shown for clarity. Wireless communication device 100 may comprise a telephone, computer, e-book, mobile Internet appliance, media player, game console, wireless network interface card, or some other wireless communication apparatus—including combinations thereof.

Wireless communication transceiver 101 comprises RF communication circuitry and an antenna. The RF communication circuitry typically includes an amplifier, filter, RF modulator, and signal processing circuitry. Wireless communication transceiver 101 may also include a memory system, software, processing circuitry, or some other communication device. Wireless communication transceiver 101 may use various protocols, such as CDMA, GSM, UMTS, HSPA, EV-DO, EV-DO rev. A, 3GPP LTE, LTE Advanced, WiMAX, Wi-Fi, Bluetooth, Internet, telephony, or some other wireless communication format.

User interface 103 comprises components that interact with a user to receive user inputs and to present media and/or information. As shown in FIG. 1, user interface 103 includes touchscreen 107. In some examples, user interface 103 may also include a speaker, microphone, buttons, lights, display screen, touch pad, scroll wheel, communication port, or some other user input/output apparatus—including combinations thereof.

Processing circuitry 104 comprises microprocessor and other circuitry that retrieves and executes operating software 106 from memory device 105. Processing circuitry 104 may comprise a single device or could be distributed across multiple devices—including devices in different geographic areas. Processing circuitry 104 may be embedded in various types of equipment. Memory device 105 comprises a non-transitory computer readable storage medium, such as a disk drive, flash drive, data storage circuitry, or some other hardware memory apparatus. Memory device 105 may comprise a single device or could be distributed across multiple devices—including devices in different geographic areas. Memory device 105 may be embedded in various types of equipment. Processing circuitry 104 is typically mounted on a circuit board that may also hold memory device 105 and portions of wireless communication transceiver 101 and user interface 103. Operating software 106 comprises computer programs, firmware, or some other form of machine-readable processing instructions. Operating software 106 may include an operating system, utilities, drivers, network interfaces, applications, or some other type of software. When executed by processing circuitry 104, operating software 106 directs processing system 102 to operate wireless communication device 100 as described herein.

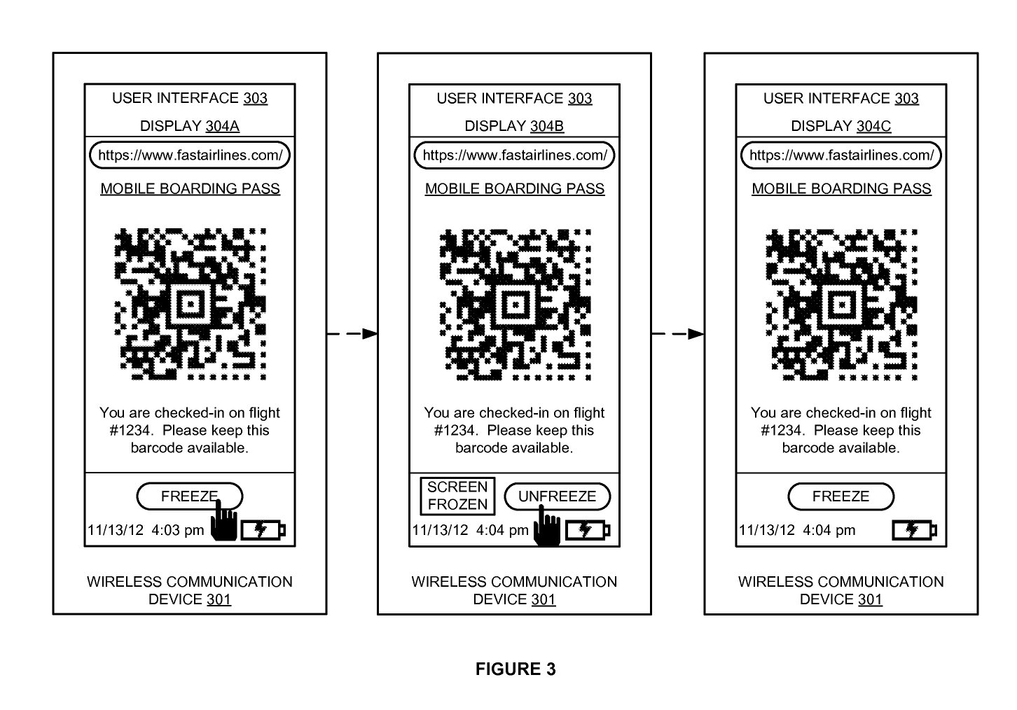

FIG. 3 is a block diagram that illustrates an operation of wireless communication device 301 in an exemplary embodiment. Wireless communication device 301 includes user interface 303. As shown in FIG. 3, user interface 303 includes a touchscreen having three different display states labeled display 304A, 304B, and 304C, respectively. Each display 304A, 304B, and 304C are different states of the display on the touchscreen of user interface 303 at different times, with display 304A being earlier in time than display 304B and 304C, display 304B occurring after display 304A, and lastly display 304C occurring later in time than display 304B.

The hand icon with the pointing finger appearing on displays 304A and 304B represents the hand of the user operating wireless communication device 301 and is not actually part of respective displays 304A and 304B. In this example, the user has accessed a mobile boarding pass on an airline website for an upcoming flight. To provide the mobile boarding pass, the airline website displays a matrix barcode, also commonly known as a quick response (QR) code, on the touchscreen of user interface 303 as shown in display 304A.

The user of wireless communication device 301 is waiting in line to board the airplane and wants to ensure that the mobile boarding pass remains on the screen so that the airline agent who will scan the pass is able to do so quickly and efficiently. As shown in the status bar area at the bottom of the screen on display 304A, the operating system of wireless communication device 301 provides the user with a “freeze” option which enables the user to freeze whatever is currently being displayed on the screen of device 301. Therefore, as represented by the solid black hand icon shown on display 304A, the user touches the “freeze” soft button in order to freeze the screen. In this example, the entire screen of user interface 303 is frozen when the user selects the “freeze” button.

Display 304B shows the state of the screen after the user has pressed the “freeze” button. In particular, the status bar has been altered by the operating system of wireless communication device 301 to now display a “screen frozen” status notification to alert the user that the “freeze” command has been processed and the screen is now in a frozen state. The user can now approach the airline ticket agent confidently knowing that the mobile boarding pass will remain on the screen of wireless communication device 301 which will help expedite the boarding process. The “freeze” soft button that was present in the status bar of display 304A has now changed to an “unfreeze” soft button which will allow the user to unfreeze the screen and return to normal operation of wireless communication device 301. Thus, after the user successfully displays the mobile boarding pass to the ticket agent and is granted access to board the airplane, the user selects the “unfreeze” soft button as shown by the solid black hand icon at the bottom of display 304B.

After the user selects the “unfreeze” option in display 304B, the status bar then reverts back to the former state as shown in display 304C, where the “screen frozen” status notification is no longer displayed, and the “unfreeze” soft button reverts to a “freeze” option. The user may now access different websites, applications, and other features of wireless communication device 301 using the normal operation of the touchscreen, and can freeze a future state of the display by once again selecting the “freeze” button if the user desires. In this manner, the user of wireless communication device 301 can ensure that whatever is displayed on the screen at the time the “freeze” option is selected will remain visible and the screen will not go dark, rotate, or be obstructed by any windows, menus, or dialog boxes until the user selects the “unfreeze” option.

In some examples, the “freeze” and “unfreeze” functions described above could be triggered by a location of wireless communication device 301. For example, wireless communication device 301 could utilize a global positioning system (GPS) or any other location determination techniques to determine its location. When wireless communication device 301 determines that device 301 is located at an airport location, device 301 could automatically freeze the display of the touchscreen, and wireless communication device 301 could also unfreeze the touchscreen in response to determining that device 301 is no longer located at the airport location. In some examples, the specific location that triggers wireless communication device 301 could be defined by the user of device 301. For example, the user of wireless communication device 301 could provide instructions that whenever device 301 is located within a specified range of a particular location, the touchscreen of device 301 should be frozen. To provide an example of this functionality in the context of FIG. 3, the user could indicate to wireless communication device 301 that the screen should be frozen within a five hundred foot radius of a security checkpoint area at the airport, and device 301 could utilize a present location of device 301 and the specified range compared to the precise GPS coordinates of the security area as the trigger to enable or disable the screen freezing functionality described above.

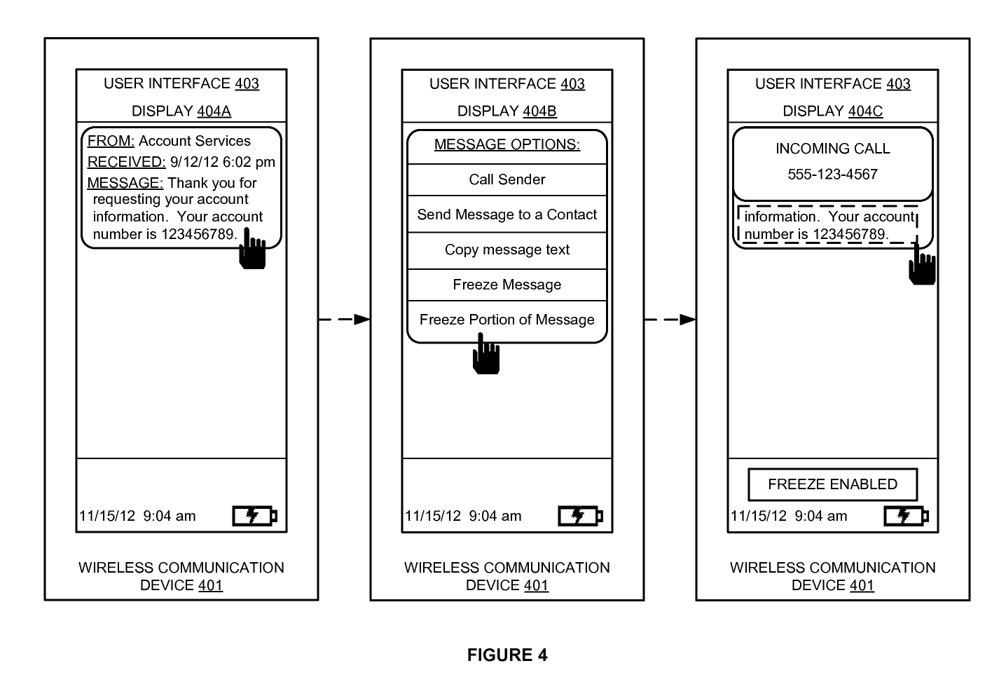

FIG. 4 is a block diagram that illustrates an operation of wireless communication device 401 in an exemplary embodiment. Wireless communication device 401 includes user interface 403. As shown in FIG. 4, user interface 403 includes a touchscreen having three different display states labeled display 404A, 404B, and 404C, respectively. Each display 404A, 404B, and 404C are different states of the display on the touchscreen of user interface 403 at different times, with display 404A being earlier in time than display 404B and 404C, display 404B occurring after display 404A, and lastly display 404C occurring later in time than display 404B.

The hand icon with the pointing finger appearing on displays 404A, 404B, and 404C represents the hand of the user operating wireless communication device 401 and is not actually part of respective displays 404A, 404B, and 404C. In this example, the user has previously requested an account number for a bank account and has received an SMS text message from Account Services providing the requested account number. The user has accessed the messaging application of wireless communication device 401 and has selected the text message containing the account number for display on the touchscreen as shown in display 403A.

While waiting in line at the bank, the user wants to ensure that the account number will still be visible and available when the user conducts a transaction with the bank teller. In this example, to freeze the account number, the user presses and holds a finger against the portion of the touchscreen displaying the text message as shown in display 404A, in order to bring up a “message options” dialog box as shown in display 404B.

The operating system of wireless communication device 401 interprets the user's touch against the message and responsively displays the “message options” dialog box as shown in display 404B. The “message options” dialog box includes options to “call sender”, “send message to a contact”, “copy message text”, “freeze message”, or “freeze portion of message”. The “freeze message” option would freeze the entire message on the portion of the touchscreen required to display the entire message. In this case, the user selects the “freeze portion of message” option as represented by the hand selecting this option on display 404B, which enables the user to freeze only a portion of the message text.

When the user selects the “freeze portion of message” option, the user then indicates to wireless communication device 401 what portion of the message the user desires to freeze. In this example, the user selects to freeze the last part of the message containing the account number, as represented by the dashed lines drawn around the words “information. Your account number is 123456789” selected by the user's finger on display 404C.

Responsive to the user selecting the portion of the message on the touchscreen to freeze, wireless communication device 401 holds that portion of the touchscreen in a frozen state and ensures that the portion of the message will be continually displayed until an unfreeze event. To indicate to the user that the freeze mode has been enabled, wireless communication device 401 displays a “freeze enabled” status notification in the status bar as shown towards the bottom of display 404C.

After the user has selected the portion of the message the user desires to freeze on the touchscreen and wireless communication device 401 is holding that portion of the message in a frozen state, an incoming call is received by wireless communication device 401. Ordinarily, wireless communication device 401 would display an incoming call notification that takes up the entire display area of user interface 403. However, in this example, because the user has frozen a portion of the message and the “freeze enabled” status indicator is displayed in the status bar, the incoming call notification is reduced and re-positioned so that it will not obstruct or interfere with the frozen portion of the message. In other examples, the incoming call notification displayed during the “freeze enabled” state might simply be a small ringing phone icon appearing in the status bar, such as next to the battery icon appearing on user interface 403. In any event, the incoming call notification does not interfere with the display of the portion of the message that is frozen.

Advantageously, the user is still able to view the account number in order to quickly expedite a transaction with the bank teller, even when an incoming call is received during the transaction that would otherwise obscure the account number under the ordinary operation of wireless communication device 401. After the transaction is complete, the user can easily unfreeze the portion of the message and restore the normal operational mode of wireless communication device 401 by either tapping the message and selecting an unfreeze option from an options menu, tapping the “freeze enabled” notification, speaking the word “unfreeze”, or providing any other user input to wireless communication device 401 that indicates a command to disable the freeze mode.

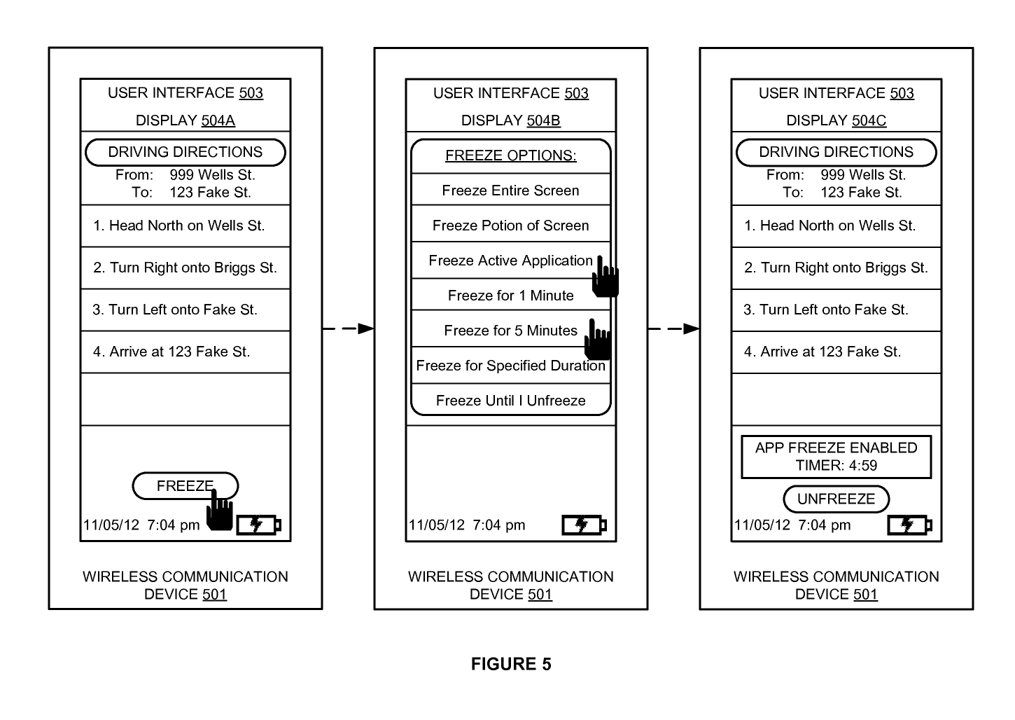

FIG. 5 is a block diagram that illustrates an operation of wireless communication device 501 in an exemplary embodiment. Wireless communication device 501 includes user interface 503. As shown in FIG. 5, user interface 503 includes a touchscreen having three different display states labeled display 504A, 504B, and 504C, respectively. Each display 504A, 504B, and 504C are different states of the display on the touchscreen of user interface 503 at different times, with display 504A being earlier in time than display 504B and 504C, display 504B occurring after display 504A, and lastly display 504C occurring later in time than display 504B.

The hand icon with the pointing finger appearing on displays 504A and 504B represents the hand of the user operating wireless communication device 501 and is not actually part of respective displays 504A and 504B. In this example, the user has accessed a map application with driving directions to a destination as shown in display 504A. At the bottom of display 504A, a soft button labeled “freeze” is provided in the status area. The user taps the “freeze” button on the touchscreen with a finger in order to access a “freeze options” menu as shown in display 504B.

The “freeze options” menu provides the user with various options related to freezing at least a portion of what is presently displayed on the touchscreen. Note that the options listed in the “freeze options” menu shown in display 504B are merely exemplary and different options could be provided in other examples, including greater or fewer options. In this example, the freeze options presented to the user include freezing the entire screen, freezing a portion of the screen, and freezing an active application. The “freeze options” menu also provides a number of options that allow the user to select the duration of time that the frozen state should continue, such as freezing for one minute, freezing for five minutes, freezing for a duration specified by the user, or simply continuing to freeze until the user indicates to wireless communication device 501 a desire to unfreeze.

In this example, the user selects the option to “freeze active application” from the “freeze options” menu as shown by the solid black hand selecting this option on display 504B. The user also selects the duration to freeze the active application by tapping the “freeze for 5 minutes” option from the “freeze options” menu. When the user selects the “freeze active application” option, whatever application is presently active and being displayed on user interface 503 will be frozen. In some examples, wireless communication device 501 could freeze an active application by ensuring that whatever image was being displayed by the application at the time the “freeze active application” option was selected will not change until the occurrence of an unfreeze event. However, in some examples, wireless communication device 501 could be configured to keep the active application on top of all other applications when the “freeze active application” option is selected, ensure that no other display elements will interfere with the active application, and maintain a brightness of the touchscreen while the active application is frozen, but still allow the user to change display screens within the active application, such as accessing various menus of the application. For example, with respect to the map application shown on user interface 503, the user could still access a map view of the driving directions, request different driving directions, and otherwise interact with and manipulate the map application while the “freeze active application” option is enabled for the map application.

After the user selects to freeze the active application for a duration of five minutes, the user is again presented with the map application with the driving directions as shown in display 504C. In this example, the status bar at the bottom of display 504C now indicates that the application is frozen by displaying an “app freeze enabled” status notification. In addition, because the user selected to freeze the application for five minutes, a countdown timer is displayed that will continue to decrement the time every second until the timer reaches zero, at which time the active application will no longer be frozen and normal operation of wireless communication device 501 will resume. The “freeze” soft button that was formerly displayed in the status bar as shown in display 504A also changes to an “unfreeze” soft button while the freeze mode is enabled, which allows the user to unfreeze the application at any time prior to expiration of the timer if the user no longer desires to have the application held in a frozen state. Further, in examples where the “freeze” and “unfreeze” functionality is triggered by a location of wireless communication device 501, the map application could be automatically unfrozen in response to device 501 arriving at the destination. Advantageously, while the map application is frozen, the user is able to continually view the driving directions without any obstructions from other applications, screen elements, or other operating system functions, enabling the user to focus on driving and safely arrive at the destination.

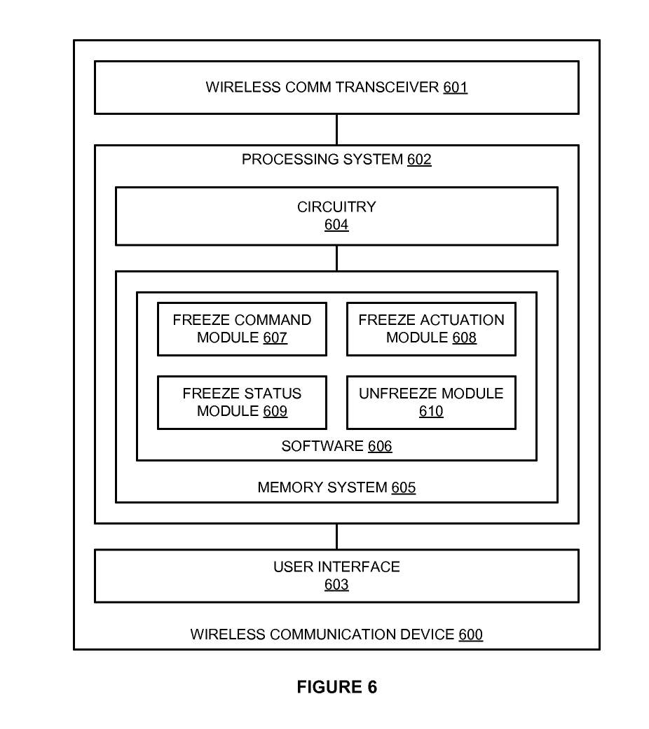

FIG. 6 is a block diagram that illustrates wireless communication device 600. Wireless communication device 600 provides an example of wireless communication devices 100, 301, 401, and 501, although devices 100, 301, 401, and 501 could use alternative configurations. Wireless communication device 600 comprises wireless communication transceiver 601, processing system 602, and user interface 603. Processing system 602 is linked to wireless communication transceiver 601 and user interface 603. Processing system 602 includes processing circuitry 604 and memory system 605 that stores operating software 606. Operating software 606 comprises software modules 607-610. Wireless communication device 600 may include other well-known components such as a battery and enclosure that are not shown for clarity. Wireless communication device 600 may comprise a telephone, computer, e-book, mobile Internet appliance, media player, game console, wireless network interface card, or some other wireless communication apparatus—including combinations thereof.

Wireless communication transceiver 601 comprises RF communication circuitry and an antenna. The RF communication circuitry typically includes an amplifier, filter, RF modulator, and signal processing circuitry. Wireless communication transceiver 601 may also include a memory system, software, processing circuitry, or some other communication device. Wireless communication transceiver 601 may use various protocols, such as CDMA, GSM, UMTS, HSPA, EV-DO, EV-DO rev. A, 3GPP LTE, LTE Advanced, WiMAX, Wi-Fi, Bluetooth, Internet, telephony, or some other wireless communication format.

User interface 603 comprises components that interact with a user to receive user inputs and to present media and/or information. User interface 603 may include a speaker, microphone, buttons, lights, display screen, touchscreen, touch pad, scroll wheel, communication port, or some other user input/output apparatus—including combinations thereof. User interface 603 may be configured to display a graphical user interface on a touchscreen, receive a freeze command from a user, and hold at least a portion of the touchscreen in a frozen state responsive to the freeze command. In addition, user interface 603 could be configured to display a status notification indicating that at least the portion of the touchscreen is in the frozen state, and unfreeze at least the portion of the touchscreen responsive to an unfreeze event.

Processing circuitry 604 comprises microprocessor and other circuitry that retrieves and executes operating software 606 from memory system 605. Processing circuitry 604 may comprise a single device or could be distributed across multiple devices—including devices in different geographic areas. Processing circuitry 604 may be embedded in various types of equipment. Memory system 605 comprises a non-transitory computer readable storage medium, such as a disk drive, flash drive, data storage circuitry, or some other hardware memory apparatus. Memory system 605 may comprise a single device or could be distributed across multiple devices—including devices in different geographic areas. Memory system 605 may be embedded in various types of equipment. Processing circuitry 604 is typically mounted on a circuit board that may also hold memory system 605 and portions of wireless communication transceiver 601 and user interface 603. Operating software 606 comprises computer programs, firmware, or some other form of machine-readable processing instructions. Operating software 606 may include an operating system, utilities, drivers, network interfaces, applications, or some other type of software. In this example, operating software 606 comprises software modules 607-610, although software 606 could have alternative configurations in other examples.

When executed by processing circuitry 604, operating software 606 directs processing system 602 to operate wireless communication device 600 as described herein for wireless communication device 100. In particular, operating software 606 directs processing system 602 to display a graphical user interface on a touchscreen of wireless communication device 600. Further, operating software 606 directs processing system 602 to receive a freeze command from a user of wireless communication device 600. Responsive to the freeze command, operating software 606 directs processing system 602 to hold at least a portion of the touchscreen in a frozen state. In addition, operating software 606 directs processing system 602 to display a status notification indicating that at least the portion of the touchscreen is in the frozen state. Finally, operating software 606 directs processing system 602 to unfreeze at least the portion of the touchscreen responsive to an unfreeze event.

In this example, operating software 606 comprises a freeze command software module 607 that receives a freeze command from a user of wireless communication device 600. Additionally, operating software 606 comprises a freeze actuation software module 608 that holds at least a portion of a touchscreen in a frozen state responsive to the freeze command. Operating software 606 also comprises a freeze status software module 609 that displays a status notification indicating that at least the portion of the touchscreen is in the frozen state. Finally, operating software 606 comprises an unfreeze software module 610 that unfreeze at least the portion of the touchscreen responsive to an unfreeze event.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a wireless communication device, the method comprising:
displaying a graphical user interface on a touchscreen of the wireless communication device;
receiving a freeze command from a user of the wireless communication device;
responsive to the freeze command, holding at least a portion of the touchscreen in a frozen state;
displaying a status notification indicating that the at least the portion of the touchscreen is in the frozen state; and
unfreezing the at least the portion of the touchscreen responsive to an unfreeze event.

2. The method of claim 1 wherein receiving the freeze command from the user comprises receiving a selection of the at least the portion of the touchscreen.

3. The method of claim 1 wherein the unfreeze event comprises an expiration of a timer.

4. The method of claim 1 wherein unfreezing the at least the portion of the touchscreen responsive to the unfreeze event comprises unfreezing the at least the portion of the touchscreen responsive to an unfreeze command from the user.

5. The method of claim 1 wherein unfreezing the at least the portion of the touchscreen responsive to the unfreeze event comprises removing the status notification indicating that the at least the portion of the touchscreen is in the frozen state.

6. The method of claim 1 wherein holding the at least the portion of the touchscreen in the frozen state comprises maintaining a brightness of the touchscreen while the at least the portion of the touchscreen is in the frozen state.

7. The method of claim 1 wherein holding the at least the portion of the touchscreen in the frozen state comprises preventing the touchscreen from rotating while the at least the portion of the touchscreen is in the frozen state.

8. The method of claim 1 wherein holding the at least the portion of the touchscreen in the frozen state comprises preventing the touchscreen from displaying an incoming call notification on the at least the portion of the touchscreen that is in the frozen state.

9. A wireless communication device comprising:
a touchscreen configured to display a graphical user interface; and
a processing system configured to receive a freeze command from a user of the wireless communication device and, responsive to the freeze command, hold at least a portion of the touchscreen in a frozen state, direct the touchscreen to display a status notification indicating that the at least the portion of the touchscreen is in the frozen state, and unfreeze the at least the portion of the touchscreen responsive to an unfreeze event.

10. The wireless communication device of claim 9 wherein the processing system configured to receive the freeze command from the user comprises the processing system configured to receive a selection of the at least the portion of the touchscreen.

11. The wireless communication device of claim 9 wherein the unfreeze event comprises an expiration of a timer.

12. The wireless communication device of claim 9 wherein the processing system configured to unfreeze the at least the portion of the touchscreen responsive to the unfreeze event comprises the processing system configured to unfreeze the at least the portion of the touchscreen responsive to an unfreeze command from the user.

13. The wireless communication device of claim 9 wherein the processing system configured to unfreeze the at least the portion of the touchscreen responsive to the unfreeze event comprises the processing system configured to remove the status notification indicating that the at least the portion of the touchscreen is in the frozen state.

14. The wireless communication device of claim 9 wherein the processing system configured to hold the at least the portion of the touchscreen in the frozen state comprises the processing system configured to maintain a brightness of the touchscreen while the at least the portion of the touchscreen is in the frozen state.

15. The wireless communication device of claim 9 wherein the processing system configured to hold the at least the portion of the touchscreen in the frozen state comprises the processing system configured to prevent the touchscreen from rotating while the at least the portion of the touchscreen is in the frozen state.

16. The wireless communication device of claim 9 wherein the processing system configured to hold the at least the portion of the touchscreen in the frozen state comprises the processing system configured to prevent the touchscreen from displaying an incoming call notification on the at least the portion of the touchscreen that is in the frozen state.

17. A computer apparatus comprising:
software instructions configured, when executed by a wireless communication device, to direct the wireless communication device to display a graphical user interface on a touchscreen of the wireless communication device, receive a freeze command from a user of the wireless communication device, responsive to the freeze command, hold at least a portion of the touchscreen in a frozen state, display a status notification indicating that the at least the portion of the touchscreen is in the frozen state, and unfreeze the at least the portion of the touchscreen responsive to an unfreeze event; and
at least one non-transitory computer-readable storage medium storing the software instructions.

18. The computer apparatus of claim 17 wherein the unfreeze event comprises an expiration of a timer.

19. The computer apparatus of claim 17 wherein the software instructions, to direct the wireless communication device to unfreeze the at least the portion of the touchscreen responsive to the unfreeze event, direct the wireless communication device to unfreeze the at least the portion of the touchscreen responsive to an unfreeze command from the user.

20. The computer apparatus of claim 17 wherein the software instructions, to direct the wireless communication device to hold the at least the portion of the touchscreen in the frozen state, direct the wireless communication device to maintain a brightness of the touchscreen while the at least the portion of the touchscreen is in the frozen state.
